(19) United States
(12) Patent Application Publication
(10) Pub. No.: US 2010/0131317 A1
(43) Pub. Date: May 27, 2010

(54) ORGANIZATION ASSESSMENT AND REPRESENTATION SYSTEM AND METHOD

(76) Inventors: Peter Duffy, Edinburgh (GB); Mark Logan, Edinburgh (GB); Neil Ross, Edinburgh (GB); Calum Smeaton, Edinburgh (GB)

Correspondence Address: HEAD, JOHNSON & KACHIGIAN, 228 W 17TH PLACE, TULSA, OK, 74119, US

(21) Appl. No.: 12/451,691

(22) PCT Filed: Nov. 28, 2007
(86) PCT No.: PCT/GB2007/004563

§ 371 Date: Nov. 24, 2009

(30) Foreign Application Priority Data
Nov. 28, 2006 (GB) 0623697.0

(51) Int. Cl. G06Q 10/00; G06F 17/30

(52) U.S. Cl. 705/7; 705/348; 707/602; 707/E17.005

(57) ABSTRACT

The invention relates to a system and method which allows the performance of an organization to be assessed with respect to data which is generated by the organization. The invention provides for the collation of data representing a number of functions of the organization, and, if necessary reformatting the same, and then processing of the same to generate results to represent the actual activities of the organisation or parts thereof and typically allow comparison with target valves.

### CROSS-REFERENCES TO RELATED APPLICATIONS

This is the United States National Phase of PCT Application No. PCT/GB2007/004563 filed 28 Nov. 2007 which claims priority to British Application No. 0623697.0 filed 28 Nov. 2006 both of which are incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The invention to which this application relates is a system and method which allows the utilisation of data relating to a particular organization and utilisation of that data so as to provide analysis and information representative of one or more aspects of that organization, which can then be provided to the organization and/or a third party in a manageable and efficient manner.

All organizations generate data of many different types and formats and the data is representative of the organizations activities. The data which is generated is typically in a raw format inasmuch that it is representative of a particular activity undertaken within the organization, and no more than that and there is little or no analysis of that data either with regard to the particular aspect of the organization by which it was generated or to assess the impact which it has, typically in combination with other data within that aspect of the organization, or across other aspects of the organization. This lack of analysis of the raw data within the organization can have a detrimental effect on the operation of various parts of the organization and the decision making process for future events. The detrimental effects can be felt more keenly in specific areas of an organization, such as those areas of an organization which are deemed to provide a service to allow the organization to function, and which may therefore be regarded as a cost generating area rather than those areas which are revenue generating.

The applicant has identified this problem and an aim of the present invention is to provide a system and method whereby raw data which is available from an organization, can be collected and then subsequently processed and analysed in order for the raw data to be used in a manageable and effective way in assisting the organization in maintaining its performance and/or ongoing development.

### BRIEF SUMMARY OF THE INVENTION

In a first aspect of the invention there is provided a system for collating and analysing data relating to an organization, said system including a plurality of data sources identified within the organization, collating means to allow data from each or selected of the data sources to be collated, and communication means to allow data from the collating means to be transmitted to a location, modelling means to allow the collated data to be assessed and analysed, in combination, via processing means and a communication portal to allow the results from the modelling and processing to be available to the organization, said results relating to selected specified aspects of the organization activities and wherein the results for a selected aspect are generated using data from said selected data sources.

In one embodiment the data sources are collated at a location under the control of the organization in question and, once collated are communicated to a remote location for subsequent data modelling and processing. In an alternative embodiment, each of the data sources are communicated directly to the location which is remote from the data sources and in whichever embodiment the data processing and the modelling take place at a centralized location.

In one embodiment the data sources are provided in a form so as to allow the most efficient capture of the raw data and said raw data, once communicated to the centralized location, may be reformatted so that all of the data is then in an acceptable or common format for the modelling and processing.

In one embodiment the data sources include any or any combination of data relating to use of telephone systems, application log files, data relating to use of network systems, data relating to use of mobile communications, data relating to use of post and/or fax communication means, use of facilities by personnel, use of home working facilities by personnel, use of publicly available services from the organization by the general public, value of property portfolios, personnel characteristics, data relating to computer applications and so on and typically the data sources can be selected with respect to each organization.

Typically the modelling which occurs, is performed in relation to specific aspects which are set by the organization, and when generating the results for each aspect, a set of rules are referred to which specify, for each aspect, the particular data or data sources that need to be referred to and taken into account.

In one embodiment, the data is received from the data sources continuously or alternatively at predetermined times.

Typically, once new data is received, the models for aspects which are live at that time will be updated to reflect any changes which may have occurred as a result of the newly received data which is deemed pertinent to those models and the updated models are then available for analysis and the subsequent results obtained, will also change as appropriate.

Typically, the communication link between the data sources and the remote location, whether indirect or direct, is secure so as to prevent any unauthorised party from gaining access to the data and, typically, the communication link via which the organization obtains access to the results, will also be secure.

In a further aspect of the invention, there is provided a method for processing data relating to an organization, said method comprising the steps of analysing the organization to identify data sources within said organization, allocating memory means to record and store data from each of the identified data sources, communicating data from the data sources from the organization to a location, identifying one or more aspects of the organization, generating one or more models for each of the identified aspects, selecting those data sources from which data is relevant for each of said models, and feeding data from the selected data sources to the respective models, processing the data to generate a series of results and indicators for each of the aspects, and providing a communication means whereby the organization can access the results.

Typically the location is a remote location to the data sources.

Typically the method involves the receipt, either continuously, or at predetermined time intervals, of data from data sources, and said new data is input into the appropriate models to update the same and update the results and indicators generated.

Typically, the method includes the steps of providing secure communication links between the organization and the remote location.

Typically the method includes the steps of reformatting data from the data sources so as to allow the same to be utilised in the models.

Typically, the results or indicators which are generated, include a visual representation which shows historical as well as current model results and indicators.

In one embodiment, the model which is created with regard to an aspect relates to a specific function or task which is required at that time rather than on an ongoing basis and, if necessary, historical data from identified data sources can be input into the model which is generated for the specific function or task.

In another embodiment the aspect represents a decision which is to be made in the future and the purpose of the model and the data used is to provide a result in the form of a prediction of an outcome or to provide results which allow the decision to be made in a more informed manner.

Typically, the data which is received at the remote location, is held in a database in a common format.

Typically, the organization with which the system or method is used, is a medium to large scale employer of personnel.

In one embodiment, the results are accessed by the organization or other authorised parties via a web portal and in one embodiment, a subscription is required to be paid to allow this access to be achieved.

One benefit of the current invention in comparison with conventional, relatively rigid, generic products, is that the turn-round in the provision of the model, analysis of the data and hence results to the organization, is relatively quick from receiving first instructions to providing the results relating to a particular aspect of the organization.

In one embodiment, the results are provided in a visual manner and, in particular, those results which relate to aspects which are monitored on an ongoing basis, are provided graphically so as to allow alterations which result from changes in the data, to be easily identified.

In one embodiment, in the method of processing the data, a series of metrics are generated which determine the weighting and/or processing of the selected data. Thus, data from certain data sources may be provided with a higher weighting than other data for a particular aspect. Furthermore, it should be appreciated that for different aspects, different weightings may be given to data than that allocated for use with other organization aspects so that, data which comes from a common data source may have different weighting values or processing parameters depending on the particular aspect in question.

Typically, the model which is generated for each aspect, will define what data to refer to, the manner in which the data should be processed, and the one or more formats in which the results should be provided to organization.

In one embodiment, the various formats of the results, can include any, or any combination of, a visual indication showing the actual status at the time of access; trends or patterns displays which show the progression of the results over a period of time; indications of the particular areas of concern in the results on ongoing investigation of those particular areas of concern, and/or predictive results which provide a prediction as to future occurrences based on data which has been processed.

In one embodiment, in order to allow the secure transfer of data from the organization to a remote location and the results from the remote location back to the organization, then encryption and verification methods can be used. In one embodiment, the encryption and verification can be performed at both the organization and the remote location.

In a further embodiment of the invention, as a result of the data which is received from the one or more data sources, performance indices can be generated which are indicative of a particular aspect or feature of the organization. The performance indices are typically generated with regard to pre-selected data sources, and the measurement of the metric of the data from those data sources which is subsequently processed using an algorithm to give a normalised value of the index.

Typically, in order to provide a performance index, a base line value is required to be generated which is then used as the value against which the index is compared on an on-going basis.

Typically, there may be provided a performance index for a group of aspects, said index being generated from performance indices for each of the said aspects and therefore a series of different levels of performance indices may be provided which allow particular problem areas to be identified and looked at in greater detail.

In a further embodiment, the data sources from which the data is received, can be split into subsets such that for example, data which is of a particular form a particular type of data source, can be split into a series of subsets which each of the subsets representing a particular geographical location, a particular department, or other division of the organization. In this arrangement, in one embodiment, the results can be generated to relate to specific locations or divisions such that only data which is identified as representing a particular division or location is used to generate the results for that division or location. This allows the performance of similar locations or divisions to be assessed and compared and furthermore, allows the identification of particular well performing or poorly performing locations and/or divisions which can be compared with regard to the overall performance of the organization, divisional or location.

In one embodiment, the method involves the steps of analysing the operations or applications of the organization to which the data relates and, with reference to the organization, placing the operations and applications into a series of levels or tiers. Typically an operation or application in each tier will utilise one or more components from lower tiers within the organization hierarchy. In one embodiment, a performance index can be generated to provide a representative indication of the performance of the said operation or application at any given instant, historically, and/or on a predicted basis.

Typically, to arrive at the performance index value, the components, in terms of the organization activities and data, which are required for the particular application or operation to be performed, are identified and, the particular way of measuring performance of each component is identified. A target range of preferred values of the performance measurement for each component is generated and, the actual performance of each component is measured and compared with the target range. As a result of this comparison a value is allocated to the component performance, said numerical value an indication of whether the target range has been met, exceeded or has failed to be met. The numerical values for each component are combined, at the same time allocating weight factors to each of said values and processing the same in an logarithm, to generate a performance index value representative of the particular application or operation.

In one embodiment, the performance index can be generated for an operation or application in any given tier of the organization by reference to components required for the same to be achieved. If the application or operation is in a relatively “high” tier of the organization, the components are operations or application on lower tiers and the performance index values which have been allocated to those operations or application can be used to generate a performance index for the selective operation or application.

Typically, for each operation or application for which a performance index value is to be generated, a specific mathematical algorithm is generated, said algorithm generated with reference to the specific components which are required for the application or operation to be performed, and an assessment of the relative importance of each of said identified components such that, for example, a component which is deemed to be critical to the performance of the operation or application, will be given a higher weighting than a component which, although required, does not have such a great impact on the overall performance of the operation or application.

This therefore provides a means whereby a series of components, the performance of each of which is typically measured in different ways, can be combined and assessed and, the results of the assessment utilised to generate a realistic and, the results of the assessment utilised to generate a realistic and usable index of performance for subsequent analysis. It therefore allows previously uncombinable data which is obtained in accordance with the invention, to be used to good effect within the organization.

Typically, the performance index values can be generated continuously to provide a real time indicator of performance, or alternatively, can be generated at spaced intervals.

### BRIEF DESCRIPTION OF THE DRAWINGS

Specific embodiments of the invention will now be described with reference to the accompanying drawings wherein;

FIG. 1 illustrates a schematic diagram of the system and method steps in accordance with the invention;

FIG. 2 illustrates the steps of FIG. 1 in more detail;

FIG. 3 illustrates a first example of use of the methods and system of the invention;

FIG. 4 illustrates a further example of the invention;

FIG. 5 illustrates a further embodiment of the invention showing an embodiment for the generation of performance index values for specific operations or applications within an organization in accordance with the invention; and

FIG. 6 illustrates one possible use of performance indices generated in accordance with the invention.

### DETAILED DESCRIPTION OF THE INVENTION

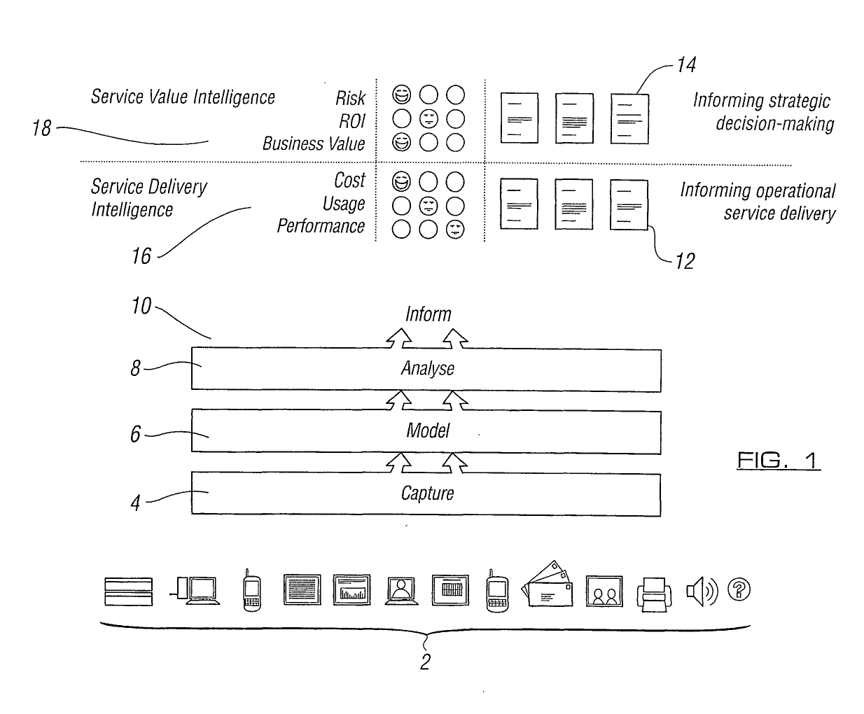

FIG. 1 illustrates in schematic fashion, one embodiment of the invention in which there is provided a representation of a plurality of data sources 2, each of which generates data which is captured by collating means such as a memory. The data sources may for example comprise any or any combination of network data, telephone records, application log files, data relating to use of the network systems, data relating to use of mobile communications, data relating to use of post and/or fax communication means, e-mail records, use of home working facilities, use of public services, property portfolios, personnel data, and/or computer applications. Typically the memory storage is provided within the organization and data is transmitted therefrom to collation means 4 which are typically located remotely from the organization. Any suitable secure communication link can be used and typically, when received the data is modified as required to place it into a common format for subsequent use.

At the remote location, there are provided a series of models 6 each of the models relating to a particular aspect of the organization, and each of the models defining the selected data sources from which data is to be retrieved and used in that particular model. Once the model has been developed and utilised the selected data is processed and analysed 8 and moved into a form to generate results 10 to inform the organization of the performance or other characteristics of the particular aspect. The results can then be generated in a range of visual manners and with regard to different interests as shown by the display 12-18, so as to provide an indication to the organization, which can access the results via a secure communication link.

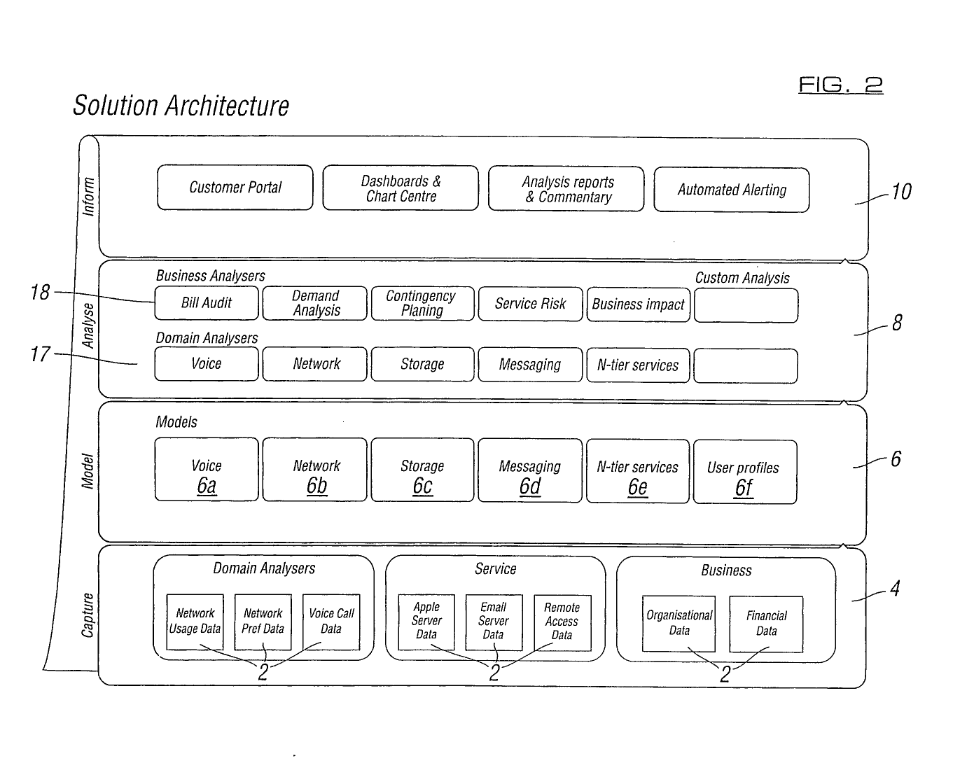

FIG. 2 illustrates FIG. 1 in more detail for a particular organization. In this case, the data sources which are used are those which generate network usage data; network performance data; voice call data; application server data; e-mail server data; remote access data; organizational data and financial data. With the data from the data sources collated, the same is then, in this case, selectively used in a series of models which represent aspects in the organization of voice usage 6a, network usage 6b, storage 6c, messaging 6d, NTier services 6e and user profiles 6f and therefore there will be provided a model for each of those aspects. Each model defines firstly, the data sources which are to be used, and secondly, the weighting to be given to each of the data sources. The analysis 8 which subsequently take place during processing of the data, can again be set in accordance with the organization and will include domain analysis which relates to each of the models and, in addition, business analysis which relates to specific features of each of the models such as bill audit; demand analysis; contingency planning; service risk and business impact and each of these analyzers can be performed for each of the models.

With this analysis having occurred, access to the results can be achieved via any of the result displays 10 such as customer portal, dashboards and a chart centre, analysis reports and commentary and/or automated alerting. The particular format generated and/or accessed can depend on the information which is sought at that time. For example, if there is a particular problem, then automated alerting may be used to make the organization aware of the problem at the earliest opportunity.

The results which are generated and indeed the models and aspects which are analysed, can be selected to provide any or any combination of strategic, tactical and operational information to the organization and may therefore change to meet particular demands at any given time. However as the data sources are already being accessed and the data retrieved, the change of models and/or analysis can be achieved relatively quickly.

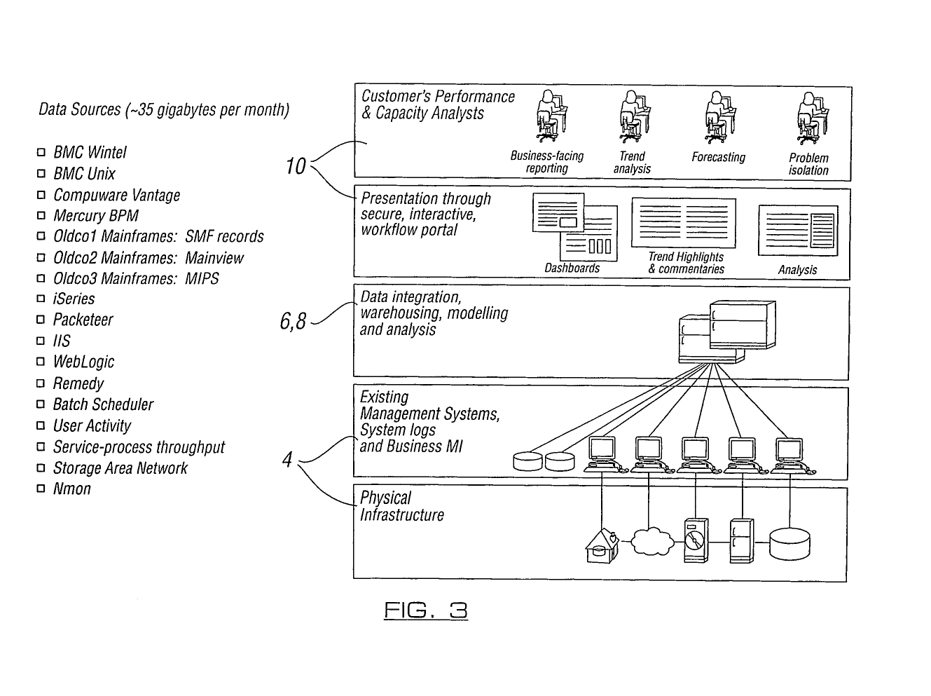

FIG. 3 illustrates a representation of a particular organization and the ability to use the current invention to provide solutions to problems in one example. In this particular case, the problem to be addressed is the ability to analyse and utilise relevant data from a relatively large organization and to process this data into results which are meaningful to the organization. In this case, the data sources 2 range from main frame servers, batch schedulers, user activity indicators, storage area networks and the like and because these are key to the operation of the organization, the same represent a useful source of data representative of the activities of the organization.

As shown in FIG. 3, the first stage is to assess the physical infrastructure and the way in which this interacts with the existing management systems and system logs. The data from these is collated by a data integration system and modelled and processed in accordance with the previous diagrams. This generates a series of results for different aspects which are generated and displayed to the user visual displays 10, and to trend highlighters and to allow commentaries of particular aspects of the same and further analysis of particular problem areas. It also results in information being provided in a form which is related to the organization and benefits realised include the improved leverage of investment in infrastructure management, lost business hours reclaimed through the avoidance of time being spent in trying to solve problems which were not clearly defined, a significant reduction in value at risk through proactive trend analysis, the resource profile was significantly widened and generally the level of intelligence of the organization about their own organization, was increased.

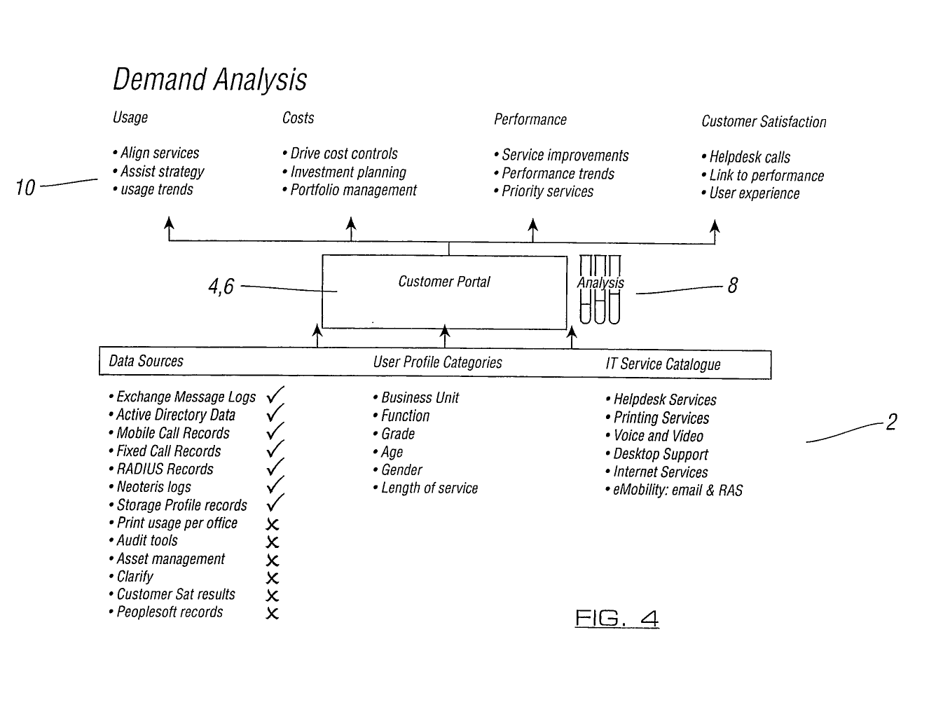

FIG. 4 illustrates a further example of the invention in which demand analysis was performed. In this case, in addition to the data sources 2, other information such as user profile categories and IT service catalogue details are also input into the collated data to form data available for use in the models and subsequent analysis. The aspects to be addressed in this case are usage of the facilities, the costs, the performance and customer satisfaction and therefore are models 6 are created for each of those four general headings and also models for each of the sub-headings which are identified. The subsequent analysis 8 generates results 10, the benefits of which were to provide informed strategic decisions with regard to IT infrastructure investment, allow improved budget planning and improved communication and messaging within the organization.

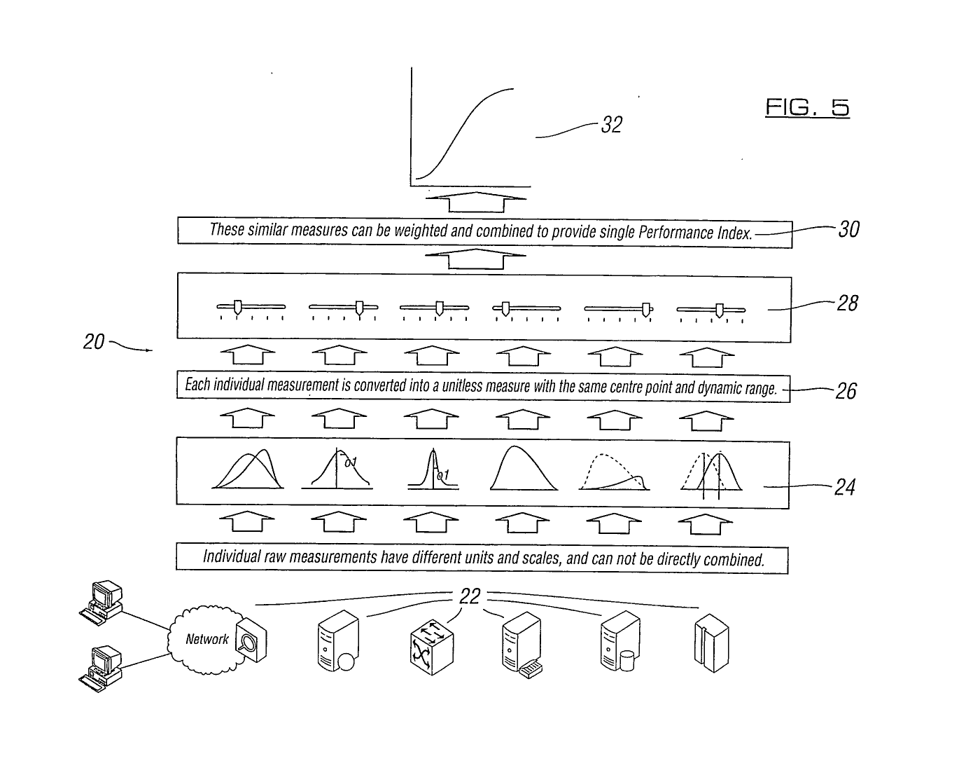

Referring now to FIG. 5, with the data which is generated in accordance with the invention, it is possible to generate one or more performance index values which allow the performance of an operation or application of the organization, to be assessed, without the need for the person viewing the index value to access all of the data generated or each component required with regard to the operation or application.

For each operation or application 20 for which the performance is required to be assessed, which for example, could be, for a financial institution, accessing details of mortgage deals which are available from the organization at any particular time, the first step is to assess the components or data sources 22 within the organization which are required to be utilised to allow the particular application or operation to be achieved. The components could, for example, be that the computer network is required to be operating, the mortgage deals database is required to be operating, the main frame computer is required to be available and/or various switches and/or routers may be required to be operable and, only all of when those components are functioning correctly, will the operation or application function as required. A range of these components 22 are shown for illustrative purposes in FIG. 5.

It will be appreciated that the data which is retrieved in accordance with the invention represents the performance of these components and is therefore available. However typically the data is in many different forms and as a result represents data which is measured in many different ways 24 such as, for example, in different time scales and/or different units. As a result it is not capable of being easily combined to provide an indication of the performance of the application. Thus, in accordance with the invention, the next stage is to define a target range 26 of measured operation for each of the components. The target range is that which, if it is met, indicates that the particular component is operating as required in a satisfactory manner.

The next stage is then to measure how the particular component is actually performing at that time and compare the measurement with the target range 28. In this example, if the measured performance is within the target range, then a value of 100 will be allocated to that component at that time. If the measured performance exceeds the target range then the value allocated would be greater than 100 and if the measured performance fails to meet the target range, the numerical value allocated will be less than 100. This is therefore undertaken for each of the components which are required for the application or operation to be performed.

With a numerical value then allocated to each of the components, and which value is allocated on the same “scale” for each component the values are input into an algorithm and weighting 30. The algorithm is generated specifically for each application or operation which is to be assessed and, in addition, to taking into account the particular component values which are required to be input, also allocates weighting values to each of the component values. The purpose of the weighting is to identify and represent the particular importance of each component to the operation or application. Thus, for example, a component which is identified as being critical to the performance of the particular operation or application, is allocated a greater weighting than a component which, although required for the application or operation, does not have such a great impact on the overall performance of the operation or application and which is provided with a lower weighting. The inputting of the component values and weightings into the algorithm then generates a performance index 32 for the operation or application which is indicative of the performance of the operation or application at that given time and/or over a period of time depending on the required analysis.

This method can be performed for operations or applications within different tiers of the organization. For example, the operation or application described previously, which is to access details of mortgage deals which are available at that time, is itself a component of a higher tier application or operation which is selling mortgages. Thus, for the selling mortgages operation or application, to provide a performance index for that application or operation, each of the required lower tier operations or applications, which are now components, which may include, for example, information of exchange rates, information of interest rates, appointment booking system, and so on, are identified. An algorithm is generated with regard to each of the required components and again a weighting value is applied to each of the said components. As the performance index values have already been generated for the lower tier components it is those performance index values which can be used in the algorithm with the appropriate weighting values and therefore a performance index for the higher tier operation or application is generated.

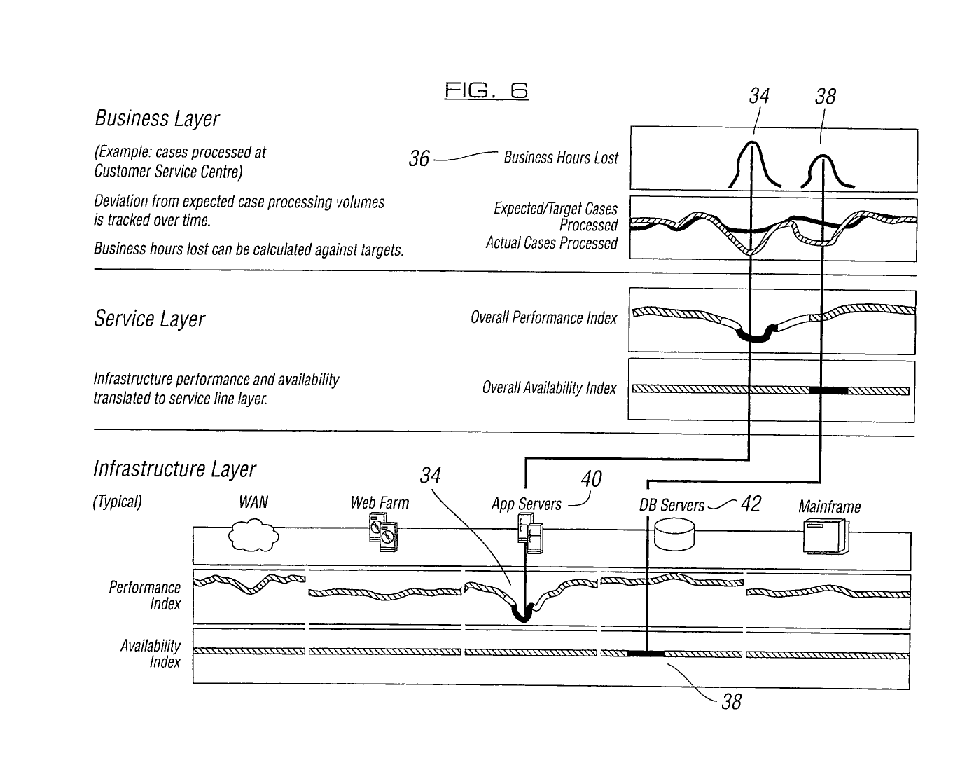

FIG. 6 illustrates a further level of information which can be provided to an organization by utilising the performance index values to generate, graphically, an indication of the impact of particular problems within the infrastructure of an organization. It allows analysis to be made of the impact of those particular problems throughout the performance of the organization. For example, it will be seen from portion 34 that the performance index indicates a particular problem when the index value was low and did not meet the required targets. The problem is seen to be allocated to the fact that the application servers 40 were not available or are malfunctioning and the actual impact on the organization is shown in terms of business hours lost as indicated by portion 36. The same is also applicable to portion 38 which shows further business hours which were lost, in this case as a result of the database servers 42 not being available for a particular time.

In one embodiment the analysis of the performance based on the data can be undertaken with respect to a baseline value, i.e. a predetermined value which is regarded as being the minimum acceptable or average acceptable performance and the actual performance can be determined with respect to this. Alternatively, or in addition a “normal” performance indication can be generated and, in one embodiment, the “normal” performance indication can be updated at intervals or continuously. The normal performance can be provided for each application and if the actual performance deviates from this normal profile, the same can relatively easily be identified.

In addition or alternatively to the determination of performance of the organization the new data can be collated, and processed in accordance with the principles of the invention and then analysed to provide data indicative of the capacity of the organisation, typically allowing comparison between a predetermined capacity level of the organisation or application within the organisation and the actual capacity levels.

There is therefore provided in accordance with the invention, a system and method which allows data which is generated by an organisation, to be collated, and then subsequently reformatted and processed in a particular way so as to allow a range of information to be available which is representative of the performance of the organisation.

1. A system for collating and analysing data relating to an organization, said system comprising:
a plurality of data sources, identified within the organization;
collating means to allow data from each or selected ones of the data sources to be collated;
communication means to allow data from the collating means to be transmitted to a location;
modelling means to allow the collated data to be assessed and analyzed, in combination, via processing means and a communication portal to allow the results from the modelling and processing to be available to the organization, said results relate to selected specified aspects of the organization activities and wherein the results for a selected aspect are generated using data from said selected data sources.

2. A system according to claim 1 wherein the data sources are collated at a location under the control of the organization in question and, once collated, are communicated to the remote location for subsequent data modelling and processing.

3. A system according to claim 1 wherein each of the data sources communicates directly to the location which is remote from the data sources.

4. A system according to claim 1 wherein the data processing and modelling takes place at the centralized location.

5. A system according to claim 1 wherein the data sources are provided in a form so as to allow the most efficient capture of the raw data and said raw data, once communicated to the centralized location, is reformatted so that all of the data is then in an acceptable or common format for the modelling and processing.

6. A system according to claim 1 wherein the data sources include any or any combination of data relating to use of telephone systems, data relating to use of network systems, data relating to use of mobile communications, application log data, data relating to use of post and/or fax communication means, use of facilities by personnel, use of home working facilities by personnel, use of publicly available services from the organization by the general public, value of property portfolios, personnel characteristics, data relating to computer applications.

7. A system according to claim 6 wherein the data sources can be selected with respect to each organization.

8. A system according to claim 1 wherein the modelling is performed in relation to specific aspects which are set by the organization, and when generating the results for each aspect, a set of rules are referred to which specify, for each aspect, the particular data or data sources that need to be referred to and taken into account.

9. A system according to claim 1 wherein the data is received from the data sources continuously.

10. A system according to claim 1 wherein the data is received from the data sources at predetermined times.

11. A system according to claim 1 wherein new data received causes the models for aspects which are live at that time to be updated to reflect any changes which may have occurred as a result of the new received data which is deemed pertinent to those models and the updated models are then available for analysis

12. A system according to claim 1 wherein the communication link between the data sources and the remote location, whether indirect or direct, are secure.

13. A system according to claim 1 wherein the communication link via which the organization obtains access to the results, will also be secure.

14. A method for processing data relating to an organization, said method comprising the following steps:
analyzing the organization to identify data sources within said organization;
allocating memory means to record and store data from each of the identified data sources;
communicating data from the data sources from the organization to a location,
identifying one or more aspects of the organization;
generating one or more models for each of the identified aspects;
selecting those data sources from which data is relevant for each of said models, and
feeding data from the selected data sources to the respective models,
processing the data to generate a series of results and indicators for each of the aspects, and providing a communication means whereby the organisation can access the results.

15. A method according to claim 14 wherein the method involves the receipt, continuously, of data from data sources, and said new data is input into the appropriate models to update the same and update the results and indicators generated.

16. A method according to claim 15 wherein the method involves the receipt at predetermined time intervals of data from data sources, and said new data is input into the appropriate models to update the same and update the results and indicators generated.

17. A method according to claim 14 wherein the method includes the step of reformatting data from the data sources so as to allow the same to be utilized in the models.

18. A method according to claim 14 wherein the results or indicators which are generated, include a visual representation which shows historical and/or current model results and indicators.

19. A method according to claim 14 wherein the model which is created with regard to an aspect relates to a specific function or task which is required at that time.

20. A method according to claim 19 wherein historical data from identified data sources, is input into the model which is generated for the specific function or task.

21. A method according to claim 14 wherein the aspect represents a decision which is to be made in the future and the purpose of the model and the data used is to provide a result in the form of a prediction of an outcome.

22. A method according to claim 14 wherein the data which is received at the remote location, is held in a database in a common format.

23. A method according to claim 14 the results are accessed via a web portal.

24. A method according to claim 14 wherein the results are provided graphically.

25. A method according to claim 14 wherein a series of metrics are generated which determine the weighting and/or processing of the selected data for a particular aspect.

26. A method according to claim 25 wherein for different aspects, different weightings may be given to data than that allocated for use with other organization aspects.

27. A method according to claim 14 wherein performance indices are generated which are indicative of a particular aspect or feature of the organization.

28. A method according to claim 27 wherein performance indices are generated with regard to pre-selected data sources, and the measurement of the metric of the data from those data sources which is subsequently processed using an algorithm to give a normalised value of the index.

29. A method according to claim 28 wherein in order to provide a performance index, a base line value is generated which is then used as the value against which the index is compared on an on-going basis.

30. A method according to claim 28 wherein there is provided a performance index for a group of aspects, said index being generated from performance indices for each of the said aspects.

31. A method according to claim 28 wherein a target range of preferred values of the performance measurement for each component is generated and, the actual performance of each component is measured and compared with the target range, and a value is allocated to the component performance, to indicate whether the target range has been met, exceeded or has failed to be met.

32. A method according to claim 31 wherein the numerical values for each component are combined, at the same time, allocating weight factors to each of said values and processing the same in an logarithm, to generate a performance index value representative of the particular application or operation.
